(19) United States
(12) Patent Application Publication
(10) Pub. No.: US 2012/0257180 A1
(43) Pub. Date: Oct. 11, 2012

(54) METHOD OF CLEANING PIPE OF IMMERSION EXPOSURE APPARATUS, AND METHOD OF MANUFACTURING DEVICE

(75) Inventors: Masayuki TANABE, Utsunomiya-shi (JP); Keiko CHIBA, Utsunomiya-shi (JP); Tatsuya HAYASHI, Utsunomiya-shi (JP)

(73) Assignee: CANON KABUSHIKI KAISHA, Tokyo (JP)

(21) Appl. No.: 13/439,015

(22) Filed: Apr. 4, 2012

(30) Foreign Application Priority Data
Apr. 5, 2011 (JP) 2011-084075

(51) Int. Cl. G03B 27/52

(52) U.S. Cl. 355/30

(57) ABSTRACT

A method of cleaning a supply pipe of an immersion exposure apparatus includes a cycle including a step of increasing a flow rate of a cleaning liquid via a supply pipe, which supplies a liquid to a gap between a substrate and a final surface of a projection optical system, and a step of decreasing the flow rate, wherein the cycle is executed a plurality of times after one of completion of one of setting and maintenance of the immersion exposure apparatus and completion of exposure of at least one substrate, and before exposure of a first shot region on a new substrate using the immersion exposure apparatus.

### BACKGROUND OF THE INVENTION

1. Field of the Invention

The present invention relates to a method of cleaning a pipe for an immersion exposure apparatus, and a method of manufacturing a device.

2. Description of the Related Art

Conventionally, reduction projection exposure which uses ultraviolet rays has been performed as a lithography method for manufacturing finely patterned semiconductor devices such as a semiconductor memory and a logic circuit. In recent years, with an increase in packing density, the pattern size has increasingly reduced, so a demand has arisen to improve the performance of a method of manufacturing a semiconductor. Especially, it is of prime importance to improve the resolution at which a pattern is transferred onto a wafer, so a variety of transfer schemes are now under study and development.

Among them, the so-called immersion exposure method is known to practically shorten the wavelength of exposure light. In the immersion exposure method, a wafer is exposed to light while the gap between the wafer surface and the wafer-side surface (final surface) of the final optical element of a projection system is filled with a liquid (immersion liquid) having a refractive index higher than that of air, instead of filling this gap with air.

To fill the gap between the wafer and the final lens of the projection optical system with a liquid, it is necessary to supply the liquid so it does not spill onto the surrounding portions. It is also necessary to supply the liquid so no gases remain in the liquid because gases remaining in the liquid may lead to an exposure failure. Japanese Patent Laid-Open No. 2007-504662 describes an immersion exposure technique in which the fluid pressure in a recover pipe formed by a porous member is set as low as, for example, 1,000 Pa or less to suppress generation of noise due to mixture of the air in the liquid in the liquid immersion area when this liquid is recovered via the recover pipe.

Before the start of an exposure process by an immersion exposure apparatus, an immersion liquid must be stably supplied to the liquid immersion area between a wafer and the final surface of a projection optical system. To stably supply an immersion liquid, it is necessary to allow a supply pipe for the immersion liquid to supply the immersion liquid so no air bubbles remain in the immersion liquid. If air bubbles remain in the immersion liquid that fills the supply pile, the residual air bubbles may move into the optical path between the wafer and the final surface of the projection optical system during exposure, resulting in an exposure failure. If it takes a long time to fill the supply pile with the immersion liquid so as to remove these residual gases from the supply pipe, the throughput of the immersion exposure apparatus lowers.

### SUMMARY OF THE INVENTION

In view of this, the present invention provides a method of cleaning a pipe of an immersion exposure apparatus so as to stably supply an immersion liquid to the liquid immersion area.

The present invention in its one aspect provides a method of cleaning a supply pipe of an immersion exposure apparatus that includes a projection optical system which projects a pattern of an original onto a substrate, and the supply pipe which supplies a liquid to a gap between the substrate and a final surface of the projection optical system, and exposes the substrate to light while the gap is filled with the liquid, the method comprising a cycle including an increasing step of increasing a flow rate of a cleaning liquid via the supply pipe, and a decreasing step of decreasing the flow rate, wherein the cycle is executed a plurality of times after one of completion of one of setting and maintenance of the immersion exposure apparatus and completion of exposure of at least one substrate, and before exposure of a first shot region on a new substrate using the immersion exposure apparatus.

Further features of the present invention will become apparent from the following description of exemplary embodiments with reference to the attached drawings.

### BRIEF DESCRIPTION OF THE DRAWINGS

FIG. 1 is an overall schematic view of an immersion exposure apparatus;

FIG. 2 is a schematic sectional view of the portion around the liquid immersion area of the immersion exposure apparatus;

FIG. 3 is a schematic view of a projection optical system, a supply pipe, and a recover pipe when viewed from the side of the liquid immersion area of the immersion exposure apparatus;

FIG. 4 is a view showing how the supply pipe and recover pipe are cleaned according to the first and second embodiments;

FIG. 5 is a view showing how the supply pipe and recover pipe are cleaned according to the first and second embodiments;

FIGS. 6A to 6D are timing charts each showing a temporal change in flow rate of an immersion liquid supplied to each of the supply pipe and recover pipe when they are cleaned in the first to third embodiments;

FIG. 7 is a view showing how the supply pipe and recover pipe are cleaned according to the third embodiment; and

FIG. 8 is a view showing how the supply pipe and recover pipe are cleaned according to the third embodiment.

### DESCRIPTION OF THE EMBODIMENTS

A method of cleaning a supply pipe which supplies a liquid (immersion liquid) to the gap (liquid immersion area) between a substrate and the final surface of a projection optical system in an immersion exposure apparatus, and a recover pipe which recovers the liquid from this gap will be described below with reference to the accompanying drawings. The cleaning method according to the present invention is performed after completion of setting or maintenance of the immersion exposure apparatus and before the first shot region on the first substrate is exposed using the immersion exposure apparatus. Although both the supply pipe and the recover pipe are cleaned simultaneously in the first to third embodiments, the present invention is also applicable to the case wherein only the supply pipe is cleaned. Note that the same reference numerals denote the same members throughout the drawings, and a repetitive description thereof will not be given.

### First Embodiment

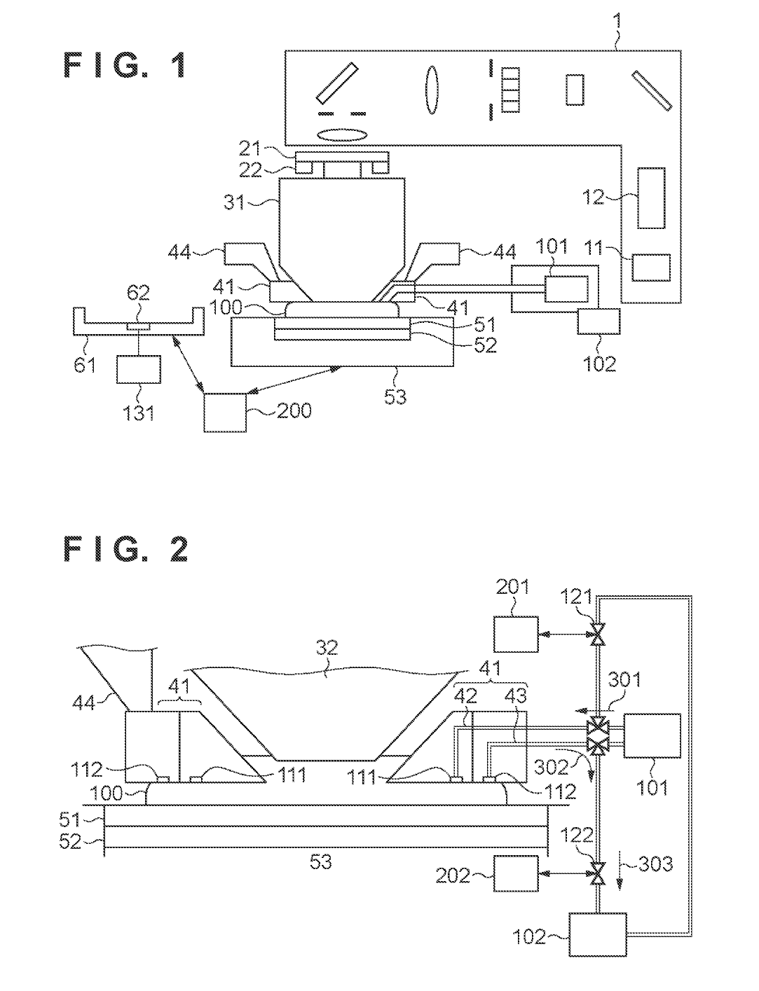

FIG. 1 shows the schematic configuration of a step-and-scan ArF immersion exposure apparatus. The immersion exposure apparatus includes an illumination system 1, a reticle stage (original stage) 22, a projection optical system 31, a wafer stage (substrate stage) 53, a supply pipe 42 which supplies an immersion liquid to a liquid immersion area 100, and a recover pipe 43 which recovers the immersion liquid from the liquid immersion area 100. The illumination system 1 which illuminates a reticle (original or mask) 21 having a pattern formed on it includes a light source unit and illumination optical system. The light source unit includes a light source 11 and an optical system 12 which shapes a beam. In this embodiment, the light source 11 uses an ArF excimer laser having a wavelength of about 193 nm. The reticle 21 is supported and driven by the reticle stage 22. The reticle 21 and a wafer 51 are located to maintain an optically conjugate relationship.

The projection optical system 31 projects the pattern of the reticle 21 onto the wafer (substrate) 51. The projection optical system 31 can use, for example, a refractive optical system including a plurality of lens elements, or a catadioptric system including a plurality of lens elements and at least one mirror element. The wafer 51 is coated with a resist and supported by the wafer stage 53 via a holder 52 such as a chuck.

The immersion exposure apparatus exposes the wafer 51 to light while the gap (liquid immersion area) between the substrate and the surface (final surface) of the final lens of the projection optical system 31, which is located nearest to the wafer 51, is filled with an immersion liquid. An immersion liquid is supplied from a supply unit 101 to the liquid immersion area 100 between the wafer 51 and the final surface of the projection optical system 31 via the supply pipe 42, and is recovered from the liquid immersion area 100 to a recovery unit 102 via the recover pipe 43. As the immersion liquid, a substance which has a high transmittance for the exposure wavelength, is greatly compatible with the resist process, and does not leave contaminants on the projection optical system 31 is selected. The immersion liquid is, for example, water or an organic liquid and is selected based on its relationships with, for example, the wavelength of exposure light and the properties of the resist coated on the wafer 51.

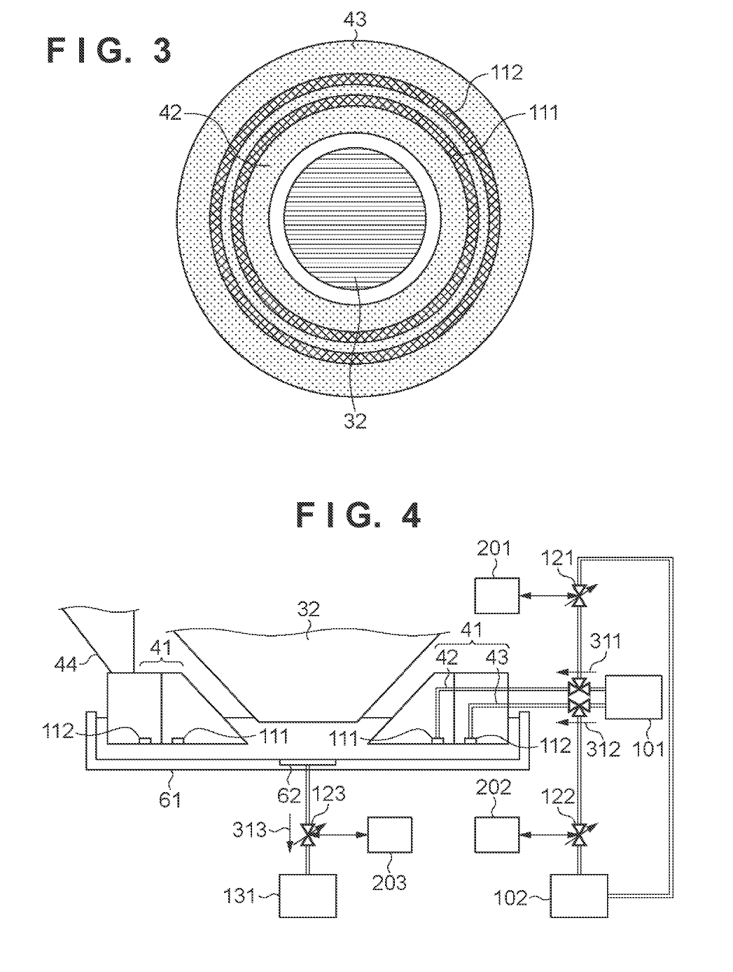

FIG. 2 shows the portion around the liquid immersion area 100. FIG. 3 is a schematic view of a nozzle 41 and a final lens 32 of the projection optical system 31 when viewed from the side of the liquid immersion area 100. The nozzle 41 is formed in an annular shape so as to surround the projection optical system 31. The nozzle 41 is supported by a support member 44 separately from the projection optical system 31, and includes the distal end portions of the supply pipe 42 and recover pipe 43. A supply port 111 formed at the distal end of the supply pipe 42 is positioned in an annular shape so as to face the wafer stage 53, and communicates with the supply unit 101 via the supply pipe 42.

A recovery port 112 formed at the distal end of the recover pipe 43 is positioned in an annular shape so as to face the wafer stage 53, and communicates with the recovery unit 102 via the recover pipe 43. In an immersion exposure process, an immersion liquid flows in a direction indicated by an arrow 301 from the supply unit 101, and is thereby supplied to the liquid immersion area 100 via the supply pipe 42 and supply port 111. Also, the immersion liquid flows in directions indicated by arrows 302 and 303 via the recovery port 112 and recover pipe 43, and is thereby recovered to the recovery unit 102.

FIG. 4 shows the state in which an immersion liquid serving as a cleaning liquid is supplied to the supply pipe 42 and recover pipe 43 to clean them. A stage controller 200 illustrated in FIG. 1 moves the wafer stage 53 present under the final lens 32 of the projection optical system 31 during immersion exposure to another position, and moves a stage 61 for filling the immersion liquid to the position below the final lens 32. As shown in FIG. 4, an immersion liquid flows in a direction indicated by an arrow 311 from the supply unit 101, and is thereby supplied to the supply pipe 42. Also, an immersion liquid flows in a direction indicated by an arrow 312 from the supply unit 101, and is thereby supplied to the recover pipe 43. The immersion liquid flowing through each of the supply pipe 42 and recover pipe 43 has a flow rate F_{A1}.

An immersion liquid supplied from the supply unit 101 flows onto the stage 61 via each of the supply pipe 42 and supply port 111 and via the recover pipe 43 and recovery port 112. The stage 61 includes a recovery port 62, which communicates with a recovery unit 131 via a pipe. The immersion liquid on the stage 61 flows in a direction indicated by an arrow 313 from the recovery port 62, and is thereby recovered to the recovery unit 131. The flow of the immersion liquid in the direction indicated by the arrow 313 is controlled by opening/closing a valve 123 controlled by a controller 203.

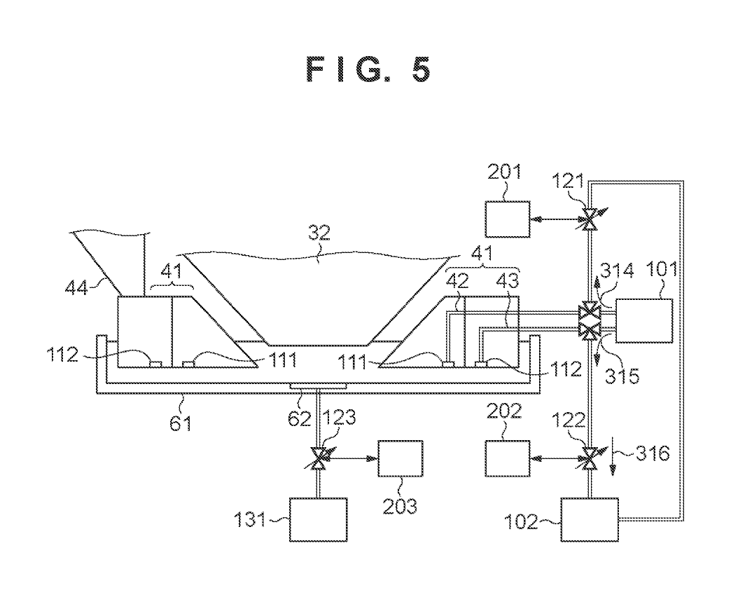

When time T_{A1} comes, a controller 201 opens a valve 121 so that part of the immersion liquid supplied to the supply pipe 42 flows in a direction indicated by an arrow 314, and is thereby recovered to the recovery unit 102, as shown in FIG. 5. At this time, the flow rate of the immersion liquid supplied to the supply pipe 42 decreases to a flow rate F_{A2}. At the same time, a controller 202 opens a valve 122 so that part of the immersion liquid supplied to the recover pipe 43 flows in directions indicated by arrows 315 and 316, and is thereby recovered to the recovery unit 102. At this time, the flow rate of the immersion liquid supplied to the recover pipe 43 decreases to the flow rate F_{A2}.

When time T_{A2} comes, the controller 201 closes the valve 121 so that the immersion liquid flows only in the direction indicated by the arrow 311 shown in FIG. 4, and the flow rate of the immersion liquid supplied to the supply pipe 42 increases and returns to the flow rate F_{A1}. At the same time, the controller 202 closes the valve 122 so that the immersion liquid flows only in the direction indicated by the arrow 312 shown in FIG. 4, and the flow rate of the immersion liquid supplied to the recover pipe 43 increases and returns to the flow rate F_{A1}.

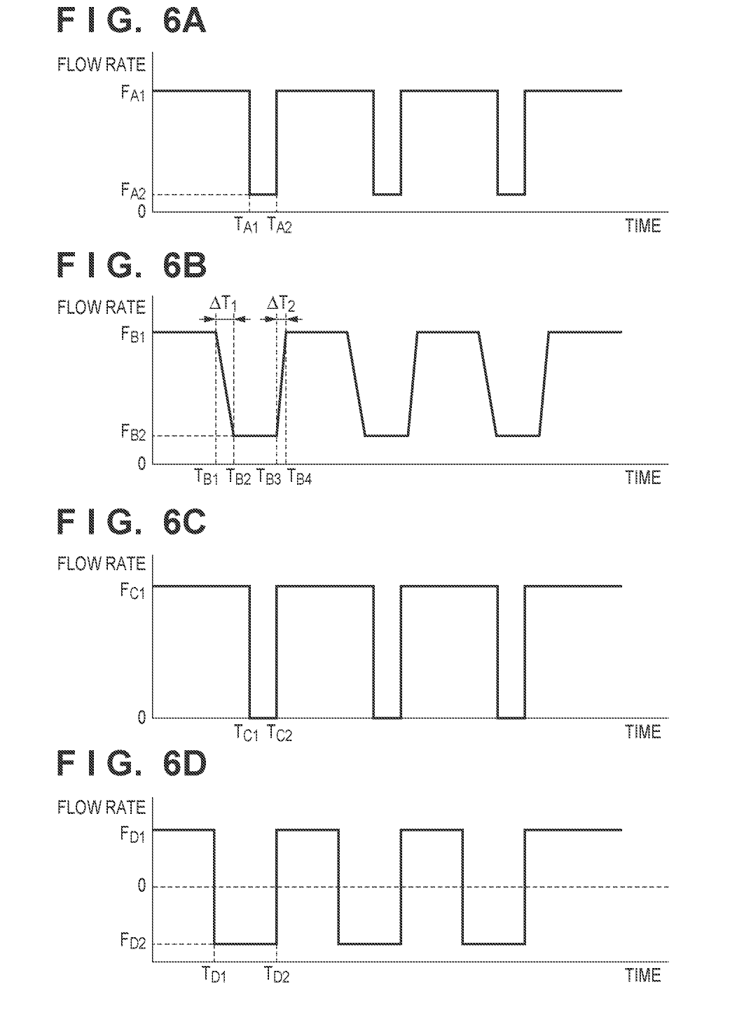

In this manner, a cycle (a cycle and a second cycle) including an increasing step of increasing the flow rate of an immersion liquid supplied via each of the supply pipe 42 and recover pipe 43, and a decreasing step of decreasing this flow rate is executed a plurality of times. The flow rate F_{A2} is a first flow rate obtained by decreasing the flow rate of the immersion liquid in the decreasing step, and the flow rate F_{A2} is a second flow rate which is obtained by increasing the flow rate of the immersion liquid in the increasing step and is higher than the first flow rate. FIG. 6A shows a temporal change in flow rate of an immersion liquid supplied to each of the supply pipe 42 and recover pipe 43 in this embodiment. For example, a decreasing step of decreasing the flow rate from the flow rate F_{A2} to the flow rate F_{A2} is executed at time T_{A1}, a maintenance step of maintaining the flow rate constant is executed in the period from time T_{A1} to time T_{A2}, and an increasing step of increasing the flow rate from the flow rate F_{A2} to the flow rate F_{A2} is executed at time T_{A2}.

After the cycle including the increasing step, maintenance step, and decreasing step described above is executed a predetermined times, the stage controller 200 moves the stage 61 for filling the immersion liquid from the position below the final lens 32 to another position, and moves the wafer stage 53 to the position below the final lens 32. The number of times of execution of the cycle may be determined based on the measurement result obtained by a measuring device which measures the number of air bubbles remaining in the supply pipe 42 and recover pipe 43. The immersion liquid is supplied from the supply unit 101 via the supply port 111 to form the liquid immersion area 100 in the gap between the final lens 32 and the wafer 51. After completion of setting or maintenance of the immersion exposure apparatus, an exposure process for the first shot region on the first wafer 51 is started using this apparatus.

In the immersion exposure apparatus according to the first embodiment, an immersion liquid is supplied to each of the supply pipe 42 which supplies the immersion liquid and the recover pipe 43 which recovers the immersion liquid, while repeatedly switching the step between an increasing step of increasing the flow rate of each of the immersion liquid supplied to the supply pipe 42 and that supplied to the recover pipe 43, and a decreasing step of decreasing this flow rate. This makes it possible to efficiently remove air bubbles from the supply pipe 42 and recover pipe 43, so no residual air bubbles adversely affect the immersion exposure apparatus. Also, since air bubbles can be removed in a short period of time, the throughput of the immersion exposure apparatus does not lower.

In the first embodiment, the flow rate of an immersion liquid is switched instantaneously, as shown in FIG. 6A. However, the flow rate of an immersion liquid may be decreased over a period of time ΔT₁, and increased over a period of time ΔT₂, as shown in FIG. 6B. Also, although immersion liquids are supplied to the supply pipe 42 and recover pipe 43 at the same flow rate in the first embodiment, they may be supplied to the supply pipe 42 and recover pipe 43 at different flow rates. Moreover, although the flow rates of immersion liquids supplied to the supply pipe 42 and recover pipe 43 are switched simultaneously in the first embodiment, they may be switched at different timings. Again, one of the supply pipe 42 and recover pipe 43 may be cleaned using an immersion liquid. The flow rate of an immersion liquid supplied to each of the supply pipe 42 and recover pipe 43 may be switched by lifting/lowering the stage 61. The flow rate of an immersion liquid supplied to each of the supply pipe 42 and recover pipe 43 may be switched by lifting/lowering the support member 44 so as to change the position of the nozzle 41.

In this embodiment, the supply pipe and the recover pipe are cleaned using an immersion liquid after completion of setting or maintenance of the immersion exposure apparatus and before the start of an exposure process for the first shot region on the first substrate. However, a cleaning process may be performed after completion of exposure of at least one substrate using the immersion exposure apparatus and before the start of an exposure process for the first shot region on a new substrate, for example, before the start of an exposure process for the first shot region on the first substrate in a lot.

Although the supply pipe and the recover pipe are cleaned using an immersion liquid on the stage 61 in this embodiment, they may be cleaned on the wafer stage 53. Also, although a mode in which the supply pipe and the recover pipe are cleaned using an immersion liquid so no air bubbles remain in the immersion liquid has been described above, they may be cleaned using, for example, a cleaning liquid, a rinsing liquid, or a protective liquid for preventing deterioration of members during apparatus suspension. Moreover, this embodiment is not limited to a step-and-scan ArF immersion exposure apparatus, and the same effect can be obtained when this embodiment is applied to a step-and-repeat exposure apparatus or an immersion exposure apparatus which employs a KrF or F₂ laser light source or an ultraviolet lamp as a light source.

### Second Embodiment

The second embodiment will be described with reference to FIGS. 4, 5, and 6C. As shown in FIG. 4, an immersion liquid flows in a direction indicated by an arrow 311 from a supply unit 101, and is thereby supplied onto a stage 61 via a supply pipe 42 and a supply port 111. Also, an immersion liquid flows in a direction indicated by an arrow 312 from the supply unit 101, and is thereby supplied onto the stage 61 via a recover pipe 43 and a recovery port 112. The immersion liquid flowing in the direction indicated by each of the arrows 311 and 312 has a flow rate F_{C1}. The immersion liquid supplied onto the stage 61 flows in a direction indicated by an arrow 313 from a recovery port 62, and is thereby recovered to a recovery unit 131.

When time T_{C1} comes, a controller 201 opens a valve 121 so that the immersion liquid flows in a direction indicated by an arrow 314, and is thereby totally recovered to a recovery unit 102, as shown in FIG. 5. At this time, the flow rate of the immersion liquid supplied to the supply pipe 42 becomes zero. At the same time, a controller 202 opens a valve 122 so that the immersion liquid flows in directions indicated by arrows 315 and 316, and is thereby totally recovered to the recovery unit 102. At this time, the flow rate of the immersion liquid supplied to the recover pipe 43 becomes zero.

When time T_{C2} comes, the controller 201 closes the valve 121 so that the immersion liquid flows in the direction indicated by the arrow 311 shown in FIG. 4, and is thereby supplied via the supply pipe 42. At the same time, the controller 202 closes the valve 122 so that the immersion liquid flows in the direction indicated by the arrow 312 shown in FIG. 4, and is thereby supplied via the recover pipe 43. The flow rate (second flow rate) of an immersion liquid supplied to each of the supply pipe 42 and recover pipe 43 is the flow rate F_{C1}. In this manner, supply and stop of an immersion liquid to each of the supply pipe 42 and recover pipe 43 are repeated. FIG. 6C shows a temporal change in supply/stop of an immersion liquid to each of the supply pipe 42 and recover pipe 43 in the second embodiment.

In the immersion exposure apparatus according to the second embodiment, supply and stop of an immersion liquid to each of the supply pipe 42 and recover pipe 43 are repeated. This makes it possible to efficiently remove air bubbles from the supply pipe 42 and recover pipe 43, so no residual air bubbles adversely affect the immersion exposure apparatus. Also, since air bubbles can be removed in a short period of time, the throughput of the immersion exposure apparatus does not lower.

### Third Embodiment

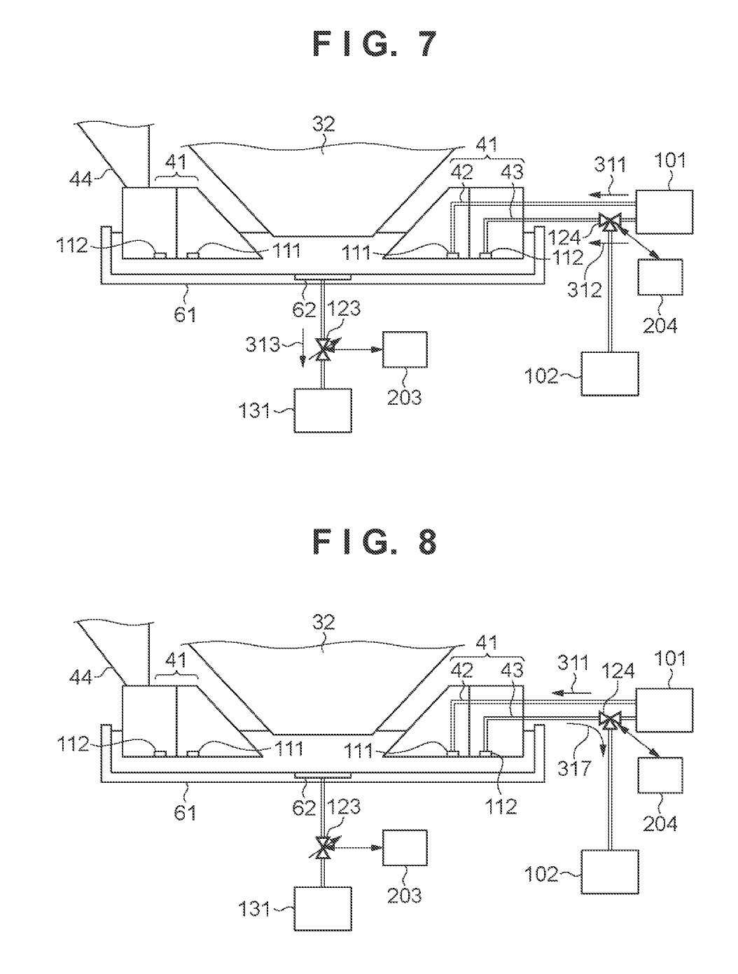

The third embodiment will be described with reference to FIGS. 6D, 7, and 8. As shown in FIG. 7, an immersion liquid flows in a direction indicated by an arrow 311 from a supply unit 101, and is thereby supplied to a supply pipe 42. Also, an immersion liquid flows in a direction indicated by an arrow 312 from the supply unit 101, and is thereby supplied to a recover pipe 43. At this time, the immersion liquid flowing through the recover pipe 43 has a flow rate F_{D1}. These immersion liquids flow onto a stage 61 via the supply pipe 42 and a supply port 111 and via the recover pipe 43 and a recovery port 112. The liquid on the stage 61 flows in a direction indicated by an arrow 313 from a recovery port 62, and is thereby recovered to a recovery unit 131.

When time T_{D1} comes, a controller 204 controls a valve 124 so that the immersion liquid flows in a direction indicated by an arrow 317, and is thereby recovered to a recovery unit 102, as shown in FIG. 8. Thus, the direction in which the immersion liquid flows through the recover pipe 43 is reversed, and its flow rate becomes a flow rate F_{D2}. When time T_{D2} comes, the controller 204 controls the valve 124 so that the immersion liquid flows in the direction indicated by the arrow 312 shown in FIG. 7, and the direction in which the immersion liquid flows through the recover pipe 43 is reversed again. In this manner, switching of the direction in which the immersion liquid supplied to the recover pipe 43 flows is repeated. FIG. 6D shows a temporal change in flow rate of an immersion liquid that flows through the recover pipe 43 upon defining the direction indicated by the arrow 312 as the positive direction, and the direction indicated by the arrow 313 as the negative direction.

In the third embodiment, the recover pipe 43 is cleaned by executing a cycle including a first increasing step, first decreasing step, second increasing step, and second decreasing step by a plurality of times. In the first increasing step, the flow rate of an immersion liquid supplied to the recover pipe 43 in a first direction is increased. In the first decreasing step, the flow rate of the immersion liquid supplied in the first direction is decreased. In the second increasing step, the direction in which the immersion liquid is supplied is switched from the first direction to a second direction opposite to the first direction, and the flow rate of the immersion liquid supplied in the second direction is increased. In the second decreasing step, the flow rate of the immersion liquid supplied in the second direction is decreased. The cycle in the third embodiment not only includes the first increasing step, first decreasing step, second increasing step, and second decreasing step, but also includes a step of maintaining the flow rate increased in the first increasing step, and a step of maintaining the flow rate increased in the second increasing step.

In the immersion exposure apparatus according to the third embodiment, the direction in which an immersion liquid is supplied to the recover pipe 43 is repeatedly switched between a first direction and a second direction opposite to the first direction. This makes it possible to remove air bubbles from the recover pipe 43, so no residual air bubbles adversely affect the immersion exposure apparatus. Also, since air bubbles can be removed in a short period of time, the throughput of the immersion exposure apparatus does not lower.

Although the recover pipe 43 is cleaned in this embodiment, the supply pipe 42 alone or both the supply pipe 42 and the recover pipe 43 may be cleaned. Also, although the direction in which an immersion liquid supplied to the recover pipe 43 flows is repeatedly reversed, the direction in which an immersion liquid flows in the recover pipe 43 may be changed locally. As a method of the latter, a method of driving a support member 44 to change the position of the recover pipe 43 or lifting/lowering the stage 61 is available. Alternatively, the direction in which an immersion liquid flows in a nozzle may be changed by increasing the numbers of supply ports 111 and recovery ports 112, and repeatedly switching the port which supplies an immersion liquid and that which recovers the immersion liquid.

[Method of Manufacturing Device]

A method of manufacturing a device (for example, a semiconductor device or a liquid crystal display device) according to an embodiment of the present invention will be described next. A semiconductor device is manufactured by a preprocess of forming an integrated circuit on a wafer (substrate), and a post-process of completing, as a product, a chip of the integrated circuit formed on the wafer by the preprocess. The preprocess includes a step of exposing a wafer, coated with a photosensitive agent, using the above-mentioned immersion exposure apparatus, and a step of developing the wafer exposed in the exposing step. The post-process includes an assembly step (dicing and bonding) and packaging step (encapsulation). A liquid crystal display device is manufactured by a step of forming a transparent electrode. The step of forming a transparent electrode includes a step of coating a photosensitive agent on a glass substrate on which a transparent conductive film is deposited, a step of exposing the glass substrate, coated with the photosensitive agent, using the above-mentioned immersion exposure apparatus, and a step of developing the glass substrate. The method of manufacturing a device according to this embodiment can manufacture a device with a quality higher than that of a device manufactured by the related art technique.

While the present invention has been described with reference to exemplary embodiments, it is to be understood that the invention is not limited to the disclosed exemplary embodiments. For example, the methods described in the above-mentioned respective embodiments may be combined as needed and used as a method of changing the flow rate of the supplied liquid/the direction in which the supplied liquid flows. The scope of the following claims is to be accorded the broadest interpretation so as to encompass all such modifications and equivalent structures and functions.

This application claims the benefit of Japanese Patent Application No. 2011-084075 filed Apr. 5, 2011, which is hereby incorporated by reference herein in its entirety.

What is claimed is:

1. A method of cleaning a supply pipe of an immersion exposure apparatus that includes a projection optical system which projects a pattern of an original onto a substrate, and the supply pipe which supplies a liquid to a gap between the substrate and a final surface of the projection optical system, and exposes the substrate to light while the gap is filled with the liquid, the method comprising
a cycle including an increasing step of increasing a flow rate of a cleaning liquid via the supply pipe, and a decreasing step of decreasing the flow rate,
wherein the cycle is executed a plurality of times after one of completion of one of setting and maintenance of the immersion exposure apparatus and completion of exposure of at least one substrate, and before exposure of a first shot region on a new substrate using the immersion exposure apparatus.

2. The method according to claim 1, wherein
the apparatus further includes a recover pipe which recovers the liquid from the gap,
the method further comprises a second cycle including an increasing step of increasing a flow rate of a cleaning liquid via the recover pipe, and a decreasing step of decreasing the flow rate, and
the second cycle is executed a plurality of times after one of completion of one of setting and maintenance of the immersion exposure apparatus and completion of exposure of at least one substrate, and before exposure of a first shot region on a new substrate using the immersion exposure apparatus.

3. The method according to claim 2, wherein each of the cycle and the second cycle further includes a step of maintaining the flow rate increased in the increasing step, and a step of maintaining the flow rate decreased in the decreasing step.

4. The method according to claim 2, wherein the flow rate is increased from a first flow rate to a second flow rate higher than the first flow rate in the increasing step of each of the cycle and the second cycle, and the flow rate is decreased from the second flow rate to the first flow rate in the decreasing step of each of the cycle and the second cycle.

5. The method according to claim 2, wherein the flow rate is increased from zero to the second flow rate in the increasing step of each of the cycle and the second cycle, and is decreased from the second flow rate to zero in the decreasing step of each of the cycle and the second cycle.

6. A method of cleaning a supply pipe of an immersion exposure apparatus that includes a projection optical system which projects a pattern of an original onto a substrate, and the supply pipe which supplies a liquid to a gap between the substrate and a final surface of the projection optical system, and exposes the substrate to light while the gap is filled with the liquid, the method comprising
a cycle including a first increasing step of increasing a flow rate of a cleaning liquid supplied in a first direction via the supply pipe, a first decreasing step of decreasing the flow rate of the cleaning liquid supplied in the first direction, a second increasing step of switching a direction in which the cleaning liquid is supplied from the first direction to a second direction opposite to the first direction, and increasing the flow rate of the cleaning liquid supplied in the second direction, and a second decreasing step of decreasing the flow rate of the cleaning liquid supplied in the second direction,
wherein the cycle is executed a plurality of times after one of completion of one of setting and maintenance of the immersion exposure apparatus and completion of exposure of at least one substrate, and before exposure of a first shot region on a new substrate using the immersion exposure apparatus.

7. The method according to claim 6, wherein
the apparatus further includes a recover pipe which recovers the liquid from the gap,
the method further comprises a second cycle including a first increasing step of increasing a flow rate of a cleaning liquid supplied in a first direction via the recover pipe, a first decreasing step of decreasing the flow rate of the cleaning liquid supplied in the first direction, a second increasing step of switching a direction in which the cleaning liquid is supplied from the first direction to a second direction opposite to the first direction, and increasing the flow rate of the cleaning liquid supplied in the second direction, and a second decreasing step of decreasing the flow rate of the cleaning liquid supplied in the second direction, and
the second cycle is executed a plurality of times after one of completion of one of setting and maintenance of the immersion exposure apparatus and completion of exposure of at least one substrate, and before exposure of a first shot region on a new substrate using the immersion exposure apparatus.

8. The method according to claim 7, wherein each of the cycle and the second cycle further includes a step of maintaining the flow rate increased in the first increasing step, and a step of maintaining the flow rate increased in the second increasing step.

9. A method of manufacturing a device, the method comprising:
exposing a substrate to light using an immersion exposure apparatus that includes a projection optical system which projects a pattern of an original onto the substrate, and a supply pipe which supplies a liquid to a gap between the substrate and a final surface of the projection optical system, and exposes the substrate to light while the gap is filled with the liquid;
developing the exposed substrate; and
processing the developed substrate to manufacture the device,
wherein a method of cleaning the supply pipe includes
a cycle including an increasing step of increasing a flow rate of a cleaning liquid via the supply pipe, and a decreasing step of decreasing the flow rate, and
the cycle is executed a plurality of times after one of completion of one of setting and maintenance of the immersion exposure apparatus and completion of exposure of at least one substrate, and before exposure of a first shot region on a new substrate using the immersion exposure apparatus.

10. A method of manufacturing a device, the method comprising:
exposing a substrate to light using an immersion exposure apparatus that includes a projection optical system which projects a pattern of an original onto the substrate, and a supply pipe which supplies a liquid to a gap between the substrate and a final surface of the projection optical system, and exposes the substrate to light while the gap is filled with the liquid;
developing the exposed substrate; and
processing the developed substrate to manufacture the device,
wherein a method of cleaning the supply pipe includes
a cycle including a first increasing step of increasing a flow rate of a cleaning liquid supplied in a first direction via the supply pipe, a first decreasing step of decreasing the flow rate of the cleaning liquid supplied in the first direction, a second increasing step of switching a direction in which the cleaning liquid is supplied from the first direction to a second direction opposite to the first direction, and increasing the flow rate of the cleaning liquid supplied in the second direction, and a second decreasing step of decreasing the flow rate of the cleaning liquid supplied in the second direction, and
the cycle is executed a plurality of times after one of completion of one of setting and maintenance of the immersion exposure apparatus and completion of exposure of at least one substrate, and before exposure of a first shot region on a new substrate using the immersion exposure apparatus.
